(19) United States
(12) Patent Application Publication
(10) Pub. No.: US 2020/0244752 A1
(43) Pub. Date: Jul. 30, 2020

(54) Processing an Event Stream Using Pattern Recognition

(71) Applicant: Oracle International Corporation, Redwood Shores, CA (US)

(72) Inventor: Jarlath TRAINOR, Belfast (IE)

(21) Appl. No.: 16/259,068

(22) Filed: Jan. 28, 2019

(51) Int. Cl. H04L 29/08; H04L 12/18; H04L 12/58

(52) U.S. Cl. CPC H04L 67/26; H04L 51/046; H04L 67/02; H04L 12/1859

(57) ABSTRACT

Embodiments process an event stream using pattern recognition to communicate with a progressive web application. A stream of events representative of a user's interactions with a web browser and a progressive web application can be received. The stream of events can be processed in combination with contextual data about the user. One of a plurality of predetermined patterns can be recognized within the stream of events. A web push message can be transmitted to the user's electronic device based on the recognized pattern, wherein content of the web push message is generated based on the one recognized pattern.

### FIELD

The embodiments of the present disclosure generally relate to processing an event stream using pattern recognition to communicate with a progressive web application.

### BACKGROUND

As Internet commerce continues to expand, consumers have generated large volumes of online activity data that relates to real world products or service offerings. In addition, potential consumers interact with online merchants in an ad-hoc manner, for example using a mobile device. As a result, the batch process of a physical trip to a brick and mortar store has been replaced by a continually available means to purchase goods or services. Thus, a system that can recognize patterns from a user's online behavior can provide timely and relevant communication to the user's electronic device, and thus improve the manner in which the user interfaces with online merchants.

### SUMMARY

The embodiments of the present disclosure are generally directed to systems and methods for processing an event stream using pattern recognition to communicate with a progressive web application. A stream of events representative of a user's interactions with a web browser and a progressive web application can be received. The stream of events can be processed in combination with contextual data about the user. One of a plurality of predetermined patterns can be recognized within the stream of events. A web push message can be transmitted to the user's electronic device based on the recognized pattern, wherein content of the web push message is generated based on the one recognized pattern.

Features and advantages of the embodiments are set forth in the description which follows, or will be apparent from the description, or may be learned by practice of the disclosure.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a system for processing an event stream using pattern recognition to communicate with a progressive web application according to an example embodiment.

FIG. 2 illustrates a block diagram of a computing device operatively coupled to a system according to an example embodiment.

FIG. 3 illustrates a system for processing an event stream using pattern recognition according to an example embodiment.

FIG. 4 illustrates a diagram for generating a web push message based on a user's activity stream according to an example embodiment.

FIG. 5 illustrates a flow diagram for transmitting a web push message to a browser according to an example embodiment.

FIG. 6 illustrates a flow diagram for processing an event stream using pattern recognition to communicate with a progressive web application according to an example embodiment.

### DETAILED DESCRIPTION

Embodiments process an event stream using pattern recognition to communicate with a progressive web application. For example, a user can interact with a website using an electronic device, and the interaction can be achieved through a progressive web application that is running on the electronic device. The progressive web application can be used to generate an experience that is similar to a native application without the need to download and store such a native application. In some embodiments, the progressive web application can include a service worker, or a script that is executed alongside the progressive web application.

While the user navigates the website, a stream of events can be generated based on the user's actions. For example, searching (e.g., for a product, category, and the like), the viewing of a product specific page, adding an item to a cart, and any other suitable action can be added to the stream of events. The stream of events can be received and processed in order to recognize patterns. For example, a plurality of patterns that are defined by one or more events can be predetermined. One of the plurality of patterns can be recognized within the stream of events when the one or more events that define the pattern matches the stream of events.

In some embodiments, the system can include contextual data, such as data about the user of the electronic device, data about the electronic device, data associated with a geographic region, and the like, and a contextual criteria can be defined. For example, one of the plurality of patterns can be recognized within the stream of events when the one or more events that define the pattern matches the stream of events and the contextual criteria can be met when the contextual data that defines the criteria matches the user/electronic device's contextual data. In another example, one or more of the predetermined patterns can include a contextual criteria in addition to the one or more defined events. In this example, these patterns are matched to the events generated by the user's interactions and to the relevant contextual information.

In some embodiments, a web push message can be transmitted to the electronic device based on the recognized pattern. For example, the recognized pattern can indicate an opportunity to engage with the user of the electronic device. An example recognized pattern that relates to an e-commerce website can be an abandoned cart. In this example, a web push message can be generated with content that relates to the abandoned cart, such as promotional materials or marketing material about the product or service abandoned from the cart.

The predetermined patterns can indicate an intent of users/visitors, and thus recognition of one of the predetermined patterns within a particular user's event stream can be used to correlate the intent associated with the predetermined pattern to the particular user. For example, a predetermined pattern that resembles an abandoned cart can be associated with an intent to purchase a product, where this intent was interrupted or otherwise changed. In this example, there is an opportunity to engage (or re-engage) with the particular user to recover this initial intent. For example, the user's intent may have been impacted by price, and thus a promotion may persuade the user to purchase the product. Other actions may similarly impact the user. Accordingly, recognition of a predetermined pattern within a user's event stream can be used to correlate an intent (e.g., an intent associated with the recognized predetermined pattern) to the user, and thus actions can be taken based on this intent, as further described herein.

In some embodiments, the recognized pattern and/or contextual information can also indicate a timing for transmitting the web push message. For example, an analysis of the user's online behavior can indicate a tendency to view products during a certain time of day (e.g., during normal weekday work hours) and to purchase products during another time of day (e.g., during lunch on weekdays, or after normal work hours). As a result, the web push message can be transmitted at a time that corresponds to the user's tendency to purchase products. Embodiments can display a web push notification corresponding to the web push message on the display of the user's electronic device using the browser/service worker/progressive web application. For example, a service worker (e.g., a script) can be running alongside(with) the progressive web application, and the service worker can be used to display the web push notification.

A progressive web application (“PWA”) refers to a web application that loads like a regular webpage or website, but functions like a native application, such as by providing offline web pages, web push notifications, and improved load times. For example, PWAs can be installable and can live on a user's home screen (e.g., without the need for an app store). PWAs can offer an immersive full screen experience and deliver the fast experience of a native application to a much larger audience on the web. The functionality for such applications can be achieved using a variety of web technologies and/or frameworks, such as Angular (AngularJS), React, Vue.js, Ember.js, JavaServer Pages (“JSP”), PHP: Hypertext Preprocessor (“PHP”), ASP.net, Hypertext Transfer Protocol (“HTTP”) 5.0, Cascading Style Sheets (“CSS”) and related frameworks, JavaScript, and any other suitable web technology and/or framework. PWAs can also include a manifest file loaded onto the user/visitor's electronic device, such as a JavaScript Object Notation (“JSON”) based manifest file that provides a centralized location for metadata. In some implementations, PWAs can leverage secure protocols (e.g., HTTPS) as well as an application shell architecture to deliver native application experiences.

Embodiments of PWAs also include/work alongside a service worker, which can serve as a network proxy in a web browser to manage requests (e.g., HTTP requests or other web requests). For example, a service worker can be downloaded/configured/installed when a user's electronic device accesses a website. In some embodiments, to implement a service worker for a website, the service worker can be registered, for example in a website's JavaScript. For example, registering a service worker can cause a web browser to download/configure/install the service worker (e.g., in the background). Accordingly, a connection can be established between a website's/PWA's JavaScript and the service worker.

In some embodiments, content for the web push notification can include an interface for engaging with the user. For instance, in the abandoned cart example, a web link (e.g., a uniform resource locator (“URL”)) that can be used to purchase the product abandoned can be included with the web push notification. In other examples, the recognized pattern can indicate other content or techniques to engage with the user, and these items can be included in the relevant web push notification.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

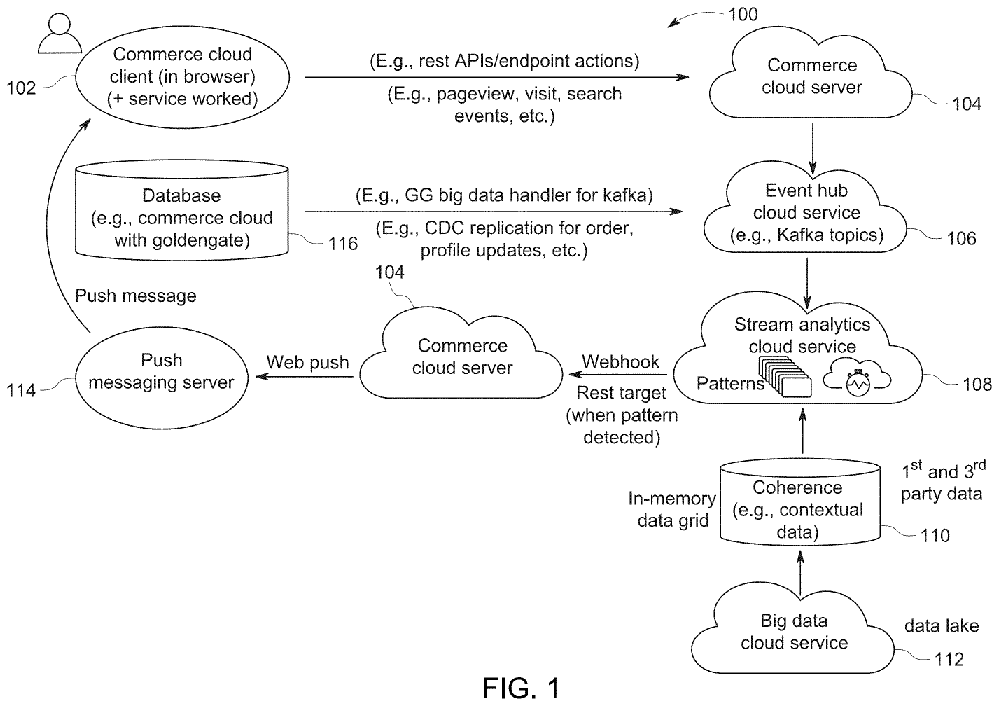

FIG. 1 is a system for processing an event stream using pattern recognition to communicate with a progressive web application according to an example embodiment. As shown in FIG. 1, system 100 includes commerce cloud client 102, commerce cloud server 104, event hub 106, stream analytics 108, coherence data 110, data lake 112, push messaging server 114, and database 116. In some embodiments, commerce cloud client 102 can include software running in a web browser of an electronic device, such as components of a progressive web application. Examples of the web browser can include Chrome®, or other suitable web browsers that run progressive web applications, such as Opera, Firefox®, Microsoft Edge®, Samsung Internet, or any other suitable commercially available browser. Embodiments include a service worker, or software script running alongside the progressive web application that can be used to provide functionality, such as displaying a web push notification. For example, the service worker can be JavaScript code that runs to enhance the functionality of the progressive web application.

In some embodiments, a user can interact with an electronic device to access a website using commerce cloud client 102. For example, the user can navigate the website by performing various actions, such as viewing different webpages or portions of webpages, searching for content, adding items to a cart, and the like. Implementations include commerce cloud client 102 running as a single-page application (“SPA”) within a web browser. In some embodiments, commerce cloud server 104 can implement the website that the user accesses using the electronic device. For example, commerce cloud server 104 can host the website and can communicate with commerce cloud client 102.

In some embodiments, commerce cloud server 104 can communicate with (or can include) event hub 106. Event hub 106 can build (consume and pipeline) a stream of events that represent actions taken by the user when navigating the website using commerce cloud 102 (e.g., and/or the electronic device, web browser, service worker, and the like). For example, the stream of events can include timestamps, where each event can be added to a data structure that holds the previous events to build (pipeline) the stream.

In some embodiments, event hub 106 can be Oracle® Event Hub Cloud Service (“EHCS”). For example, commerce cloud server 104 can represent storefront endpoint(s), which can include data annotated with metadata. In some embodiments, the framework can implement functionality such as: creating messages, serializing the messages, and posting the messages to a number of Kafka topics (e.g., in event hub 106); directing the stream of event data to the Kafka broker endpoint (e.g., exposed by event hub 106); and consuming the new Kafka topic setup to receive this incoming streaming data.

In some embodiments, event hub 106 can access database 116 when building the stream of events. Database 116 can be an operational database associated with commerce cloud server 104. For example, database 116 can store data such as orders, products, promotions, user profile, and the like. Database 112 can be a big data lake associated with commerce cloud server 104, database 112 can store data such as page views, search events, site visits, and the like (e.g., high volume data not stored in database 116).

Stream analytics 108 can receive the built stream of events and can further process the stream to recognize patterns. In some embodiments, stream analytics 108 can register as a consumer of the event stream built (or pipelined) by event hub 106. A plurality of patterns that are defined by one or more events can be predetermined, and these patterns can be accessed by stream analytics 108. One of the plurality of patterns can be recognized within the stream of events when the one or more events that define the pattern matches the stream of events.

In some embodiments, the system can include contextual data, such as data about the user of the electronic device, data about the electronic device, data associated with a geographic region, and the like, and a contextual criteria can be defined. For example, coherence data 110 and/or data lake 112 can store contextual data that can be accessed by stream analytics 108 to perform pattern recognition and other analytics. The contextual data can include first party data, third party data, forecasted or predicted data (e.g., forecasted weather data), or any other suitable contextual data.

In some embodiments, a user/visitor can be associated with a visitor identifier, such as a visitor ID. Such a visitor ID can be assigned by an identification service, such as Oracle® Commerce Cloud Service Visitor ID Service. Contextual data about a particular user/visitor can be retrieved using the corresponding visitor ID. For example, a visitor ID can be used as a reference to look up a profile, audience, RFM (recency, frequency, monetary value) cluster, or the like, in a data store (e.g., big data cloud service, NoSQL historical data store, Oracle® coherence in-memory data grid, and the like) for contextual information (e.g., the data store(s) holding a history of visit/search/page view events can be striped with visitor ID and visit ID values).

In some embodiments, one of the plurality of patterns can be recognized within the stream of events when the one or more events that define the pattern match the stream of events and the contextual criteria can be met when the contextual data that defines the criteria matches contextual data from the user, electronic device, geographic region, or relevant entity/circumstances (such as the entity/circumstances that the contextual data relates to, or a similar set of circumstances). In another example, one or more of the predetermined patterns can include a contextual criteria in addition to the one or more defined events. In this example, these patterns are matched to the stream of events generated by the user and to the relevant contextual information (e.g., the recognized pattern can be a contextual stream pattern).

Once a pattern is recognized in the stream of events, stream analytics 108 can communicate with commerce cloud 104 to generate an action in response to the recognized pattern. For example, streaming analytics 108 can invoke a REST API target/endpoint on commerce cloud 104, which can (along with push messaging server 114) generate the web push message/display the web push notification.

Embodiments include generating a web push message for transmission to the electronic device associated with the user. For example, content for a web push notification corresponding to the web push message can include an interface for engaging with the user that is based on the recognized pattern. For instance, in an abandoned cart example, a web link (e.g., a URL) that can be used to purchase the product abandoned can be included in the web push notification. In other examples, the recognized pattern can indicate other content or techniques to engage with the user, and these items can be included in the relevant web push notification. In some embodiments, other actionable content that can be generated for a web push message and displayed by the corresponding web push notification, for example based on the pattern recognized, includes a web link that can be used to add an product to a wish list, a web link that can be used register for a service (e.g., a premium service), a click-to-chat link (e.g., configured to generate a chat with a customer service representative or a chat bot), a click-to-call link (e.g., which can be clicked to execute on a call on a mobile device), an offer for a free sample (e.g., a form/web link that can be filled out to receive a free offer), one or more links to perform product reviews, content that provides shipping options, content that relates to frequently asked questions, and the like.

In some embodiments, the recognized pattern and/or contextual information can also indicate a timing for transmitting the web push message. For example, an analysis of the user's browsing actions can indicate a tendency to view products during a certain time of day (e.g., during normal weekday work hours) and to purchase products during another time of day (e.g., during lunch on weekdays, or after normal work hours). As a result, the web push message can be transmitted (or can be scheduled for transmission) at a time that corresponds to the user's tendency to purchase products.

In some embodiments, commerce cloud 104 can instruct push messaging server 114 to transmit the web push message to commerce cloud client 102 (e.g., the electronic device, web browser, service worker, and the like), for example at the determined time. A corresponding web push notification can then be displayed by the electronic device (which can be accomplished by the service worker in some examples). In some embodiments, commerce cloud client 102, commerce cloud server 104, event hub 106, stream analytics 108, coherence data 110 (e.g., Oracle® coherence in-memory data grid), data lake 112, and database 116 can be implemented using Oracle® products or services.

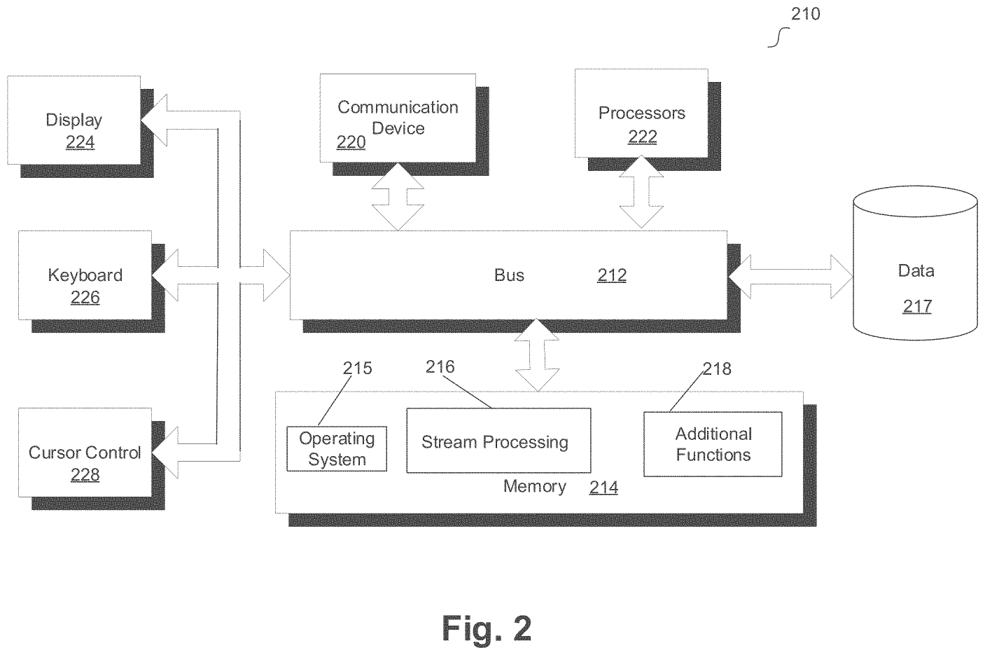

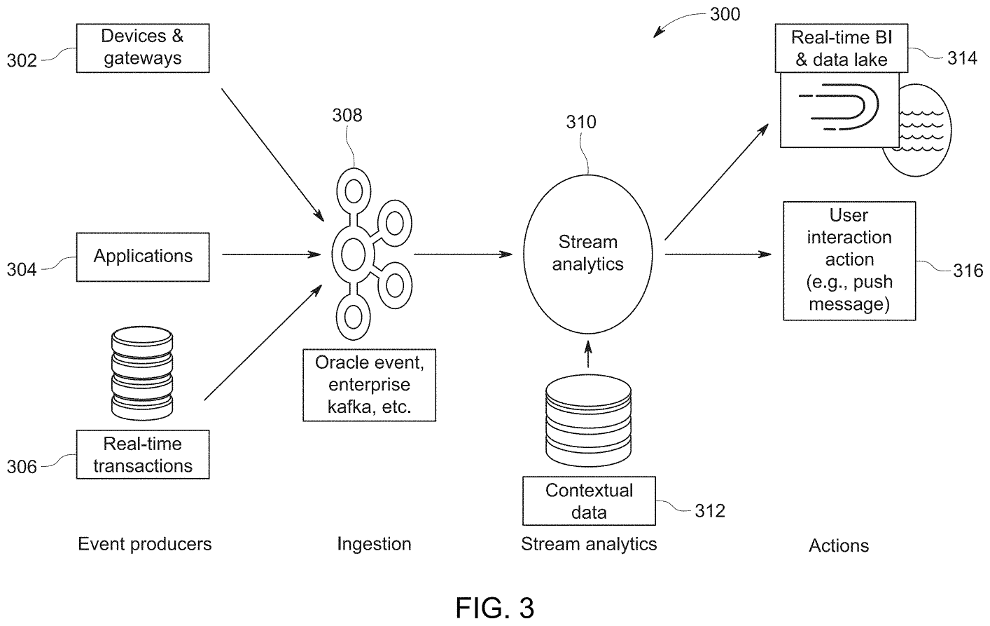

FIG. 2 is a block diagram of a computer server/system 210 in accordance with embodiments. All or portions of system 210 may be used to implement any of the elements shown in FIG. 1. As shown in FIG. 2, system 210 may include a bus device 212 and/or other communication mechanism(s) configured to communicate information between the various components of system 210, such as processor 222 and memory 214. In addition, communication device 220 may enable connectivity between processor 222 and other devices by encoding data to be sent from processor 222 to another device over a network (not shown) and decoding data received from another system over the network for processor 222.

For example, communication device 220 may include a network interface card that is configured to provide wireless network communications. A variety of wireless communication techniques may be used including infrared, radio, Bluetooth®, Wi-Fi, and/or cellular communications. Alternatively, communication device 220 may be configured to provide wired network connection(s), such as an Ethernet connection.

Processor 222 may include one or more general or specific purpose processors to perform computation and control functions of system 210. Processor 222 may include a single integrated circuit, such as a micro-processing device, or may include multiple integrated circuit devices and/or circuit boards working in cooperation to accomplish the functions of processor 222. In addition, processor 222 may execute computer programs, such as operating system 215, streaming processing module 216, and other applications 218, stored within memory 214.

System 210 may include memory 214 for storing information and instructions for execution by processor 222. Memory 214 may contain various components for retrieving, presenting, modifying, and storing data. For example, memory 214 may store software modules that provide functionality when executed by processor 222. The modules may include an operating system 215 that provides operating system functionality for system 210. The modules can include an operating system 215, streaming processing module 216 configured to perform analytics of received event stream data, as well as other applications modules 218. Operating system 215 provides operating system functionality for system 210. In some instances, streaming processing module 216 may be implemented as an in-memory configuration. When system 210 executes the functionality of streaming processing module 216, it implements as a non-conventional specialized computer system that performs the functionality disclosed herein.

Non-transitory memory 214 may include a variety of computer-readable medium that may be accessed by processor 222. For example, memory 214 may include any combination of random access memory (“RAM”), dynamic RAM (“DRAM”), static RAM (“SRAM”), read only memory (“ROM”), flash memory, cache memory, and/or any other type of non-transitory computer-readable medium.

Processor 222 is further coupled via bus 212 to a display 224, such as a Liquid Crystal Display (“LCD”). A keyboard 226 and a cursor control device 228, such as a computer mouse, are further coupled to communication device 212 to enable a user to interface with system 210.

In some embodiments, system 210 can be part of a larger system. Therefore, system 210 can include one or more additional functional modules 218 to include the additional functionality. Other applications modules 218 may include the various modules of Oracle® Commerce Cloud Service (“OCCS”), Oracle® Golden Gate, Oracle® Big Data Cloud Service (“BDCS”), Oracle® Analytics Cloud, Oracle® Stream Analytics (“OSA”), Oracle® Event Hub Cloud Service (“EHCS”), and/or an Apache® Kafka system, for example. A database 217 is coupled to bus 212 to provide centralized storage for modules 216 and 218 and to store, for example, data received from various devices. Database 217 can store data in an integrated collection of logically-related records or files. Database 217 can be an operational database, an analytical database, a data warehouse, a distributed database, an end-user database, an external database, a navigational database, an in-memory database, a document-oriented database, a real-time database, a relational database, an object-oriented database, a non-relational database, a NoSQL database, Hadoop® distributed file system (“HFDS”), or any other database known in the art.

Although shown as a single system, the functionality of system 210 may be implemented as a distributed system. For example, memory 214 and processor 222 may be distributed across multiple different computers that collectively represent system 200. In one embodiment, system 210 may be part of a device (e.g., smartphone, tablet, computer, etc.). In an embodiment, system 210 may be separate from the device, and may remotely provide the disclosed functionality for the device. Further, one or more component of system 210 may not be included. For example, for functionality as a user or consumer device, system 210 may be a smartphone or other wireless device that includes a processor, memory, and a display, does not include one or more of the other components shown in FIG. 2, and includes additional components not shown in FIG. 2, such as an antenna, transceiver, or any other suitable wireless device component.

Various embodiments can include wireless devices that run mobile browsers capable of displaying a progressive web application. For example, the wireless device can be an electronic device that is a portable communication device such as a mobile phone, smartphone, tablet, and the like. A user interface for the device may include a touchscreen and/or other input/output devices. It should be understood, however, that the user interfaces and associated methods may be applied to other devices, such as personal computers, laptops, and the like which may include one or more other physical user-interface devices, such as a keyboard and or mouse, or any other suitable user-interface device. The electronic device may support a variety of applications, such as an Internet browser, text messenger, experience management, and various other applications. The various applications that may be executed on the electronic device may use at least one common physical user-interface device. In addition, a common physical architecture of the electronic device may support a variety of applications with user interfaces that are intuitive and transparent.

Referring back to FIG. 1, embodiments include commerce cloud client 102 and commerce cloud 104 that provide progressive web application functionality. For example, commerce cloud client 102 can include a service worker, or a script that executes on an electronic device to provide a progressive web application experience. For example, commerce cloud client 102 can run alongside a web browser, such as Google® Chrome. Commerce client 102 and/or the web browser can communicate with commerce cloud 104 to enable a user to navigate a website hosted by the commerce cloud. While navigating the website, the user can utilize the web browser and commerce client 102 to view various portions of the website, such as different webpages (e.g., product web pages, and the like), to search the website, and the like. In some embodiments, a PWA can be layered on top of commerce cloud client 102. For example, a progressive web application can be installed or loaded from a commerce cloud 104 implemented website (e.g., when the user/electronic device first visits the website), and can then run alongside the web browser.

In some embodiments, commerce cloud 104 can be in communication with (or can include) event hub 106, where the event hub can build (consume and pipeline) a stream of events from the user's actions on the webpage. For example, event hub 106 can implement a cloud based and managed Apache® Kafka ecosystem. For example, a Kafka system can include producer elements and consumer elements, where the producer elements can produce a stream of events and the consumer elements can subscribe to, and consume, these event streams. A Kafka ecosystem can also include stream processing elements, which can receive a stream of events for processing, such as transforming, re-packaging, analytics (e.g., pattern recognition), and the like. Each of Kafka producer elements, consumer elements, and stream processing elements can communicate with one another based on element specific application programming interfaces (“APIs”).

In some implementations, Kafka producer elements can implement topics that can be used to organize event streams and can further implement partitions that can used to further organize/structure these event streams. Kafka consumer and stream processing elements can subscribe to certain topics and/or partitions.

Embodiments implement real time streaming data pipelines, where ingest can be managed using a Kafka message queue/conduit (e.g., within the Oracle® Event Hub Cloud Service), pattern recognition using Oracle® Stream Analytics, and visitor/user communications using progressive web technology. Insight into shopper context can be supported by a session scoped persistence layer, such as an Oracle® Coherence data cache, along with the Oracle® Big Data Cloud Service and its associated Big Data Connectors (e.g., GoldenGate Big Data Kafka Handler, and the like).

FIG. 3 illustrates a system for processing an event stream using pattern recognition according to an example embodiment, which can include the functionality of event hub 106, database 116, stream analytics 108, coherence data 110/data lake 112, commerce cloud 104, and/or push messaging server 114. For example, system 300 can represent a Kafka ecosystem that includes event producer elements, ingestion elements, stream processing elements, and elements that can take action based on the functionality of the previous Kafka elements. Embodiments of the Kafka ecosystem can include a low latency, high throughput, scalable, and decoupled message broker.

Devices and gateways 302 can include electronic devices, network components, such as gateways, and any other suitable device. Applications 304 can include software applications that can receive/produce events for publication to a stream of events, and can further include micro-services. Real-time transactions 306 can include software elements, such as a database, and that can publish real-time transactions as a stream. Each of these elements can serve as an input for Kafka producers. For example, one or more of database transaction logs, sensor data, social media data, a click stream or web activity (e.g., for a user of an electronic device), or geo-location data can be used to produce a stream of events.

Event hub 308 can be used to ingest data from the producers to build the stream of events. For example, event hub 308 can filter, aggregate, transform, correlate, and/or geofence the data from producers to build (consume and pipeline) the stream of events. In some embodiments, event hub 308 receives the input from one or more of devices and gateways 302, applications 304, and real-time transactions 306 and builds the Kafka topics and partitions that are used to structure event streams in a Kafka ecosystem. For example, one or more of devices and gateways 302, applications 304, and real-time transactions 306 can be Oracle® Cloud Commerce client producing elements.

In some embodiments, clients producing events of interest (such as page views, searches, and the like), can generate data conforming to a standard or protocol (e.g., an (Apache) Avro schema). For example, Avro schemas can be defined using JSON, and Jackson (a Java library for handling tasks like reading and writing (parsing/generating) and data binding to/from Java objects) can convert the JSON objects into generated Avro schema classes. These generated Avro schemas can then be serialized into a byte array and sent as the payload of a Kafka message. Any other suitable data formats and functional elements (e.g., Jackson substitutes) can be implemented.

In some embodiments, the data can be placed onto a Kafka topic (e.g., shared between Kafka elements, such as OCCS and EHCS). For example, data can flow from OCCS into EHCS via Kafka topics, which are defined and configured in EHCS. OCC REST endpoints can call into code which serializes data into messages to be placed onto that topic. In some embodiments, the data can be deserialized (the reverse process) at the point of consumption.

In some embodiments, a visitor ID can be associated with a particular user/visitor/electronic device (e.g., via an identification service). For example, a user can be assigned a visitor ID value by OCCS Visitor ID Service. In some embodiments, the visitor ID can be passed to event hub 308 or other Kafka ecosystem components (e.g., via Kafka messaging). For example, the visitor ID can be used to access a data store (e.g., data lake) to retrieve data (e.g., contextual data) about the user/visitor/electronic device. Based on this retrieved data different actions can be taken. For example, if the data indicates that an amount spent by the user/visitor/electronic device over a period of time meets a first threshold (e.g., is greater than $100) a first promotion can be included in a push message (e.g., 10% off) and if the data indicates that the amount spent over the period of time meets a second threshold (e.g., is greater than $200) a second promotion can be included in a push message (e.g., 20% off). Other embodiments can include other examples where the action taken (e.g., push message generated) can be based on this retrieved data.

In some embodiments, one or more event producers can include Oracle® GoldenGate Big Data Handler for Kafka, where updates to database records (such as orders and user profiles) can be replicated to a Kafka component, such as event hub 308, in real-time. In the context of Kafka, Oracle® GoldenGate provides a mechanism for streaming changes made to a table (or set of tables) and making them available to other components/processes in a pipeline. In some embodiments, event hub 308 can be an Oracle® Event Hub and/or Oracle® Stream Analytics service or any other suitable component of a Kafka Enterprise system.

Stream analytics 310 can be used to analyze the built stream of events to perform additional processing. For example, stream analytics 310 can be a Kafka stream processing element. In some embodiments, stream analytics 310 is implemented using Oracle® Event Hub and/or Oracle® Stream Analytics. Embodiments include performing pattern recognition within built streams of events using stream analytics 310. For example, a number of predetermined patterns can be defined, and stream analytics 310 can analyze built streams of events to recognize the predetermined patterns within the streams.

Example predetermined patterns that can be used to determine intent can include predefined associations or event relationships. For example, predetermined patterns can include event associations such as: ‘A’ followed by ‘B’, ‘A’ not followed by ‘B’, Detect Missing Event, Geo Code or Reverse Geo Code: Near by, Geo Fence Proximity, Geo Filter, Detect Duplicates, and other suitable patterns. A predetermined pattern with an ‘A’ followed by ‘B’ association can include event definitions for the ‘A’ and ‘B’ events, such as an ‘A’ event that adds a product to a cart and a ‘B’ event that removes the product from the cart. Other ‘A’ followed by ‘B’ examples can include: searching for a product or category and then viewing a product specific webpage; searching for a product and then searching for a specific variant of that product; canceling an order after being notified of a shipment delay; adding a product to a cart and triggering stock check that determines the item is in-stock at a nearby store; and the like.

A predetermined pattern with an ‘A’ not followed by ‘B’ association can also include event definitions for the ‘A’ and ‘B’ events, such as an ‘A’ event that adds a product to a cart and a ‘B’ event that does not include checkout of the cart (e.g., finalizing the order). Other ‘A’ not followed by ‘B’ examples can include: searching for a particular product or category and then not viewing any specific product detail page; navigating to a lowest level product category but not viewing any specific product detail page; searching for a product previously purchased by the user but not adding the product to a cart; having items in a cart but failing to checkout; checking out an order but failing to qualify for free shipping based on the total amount for the order; checking out an order but failing to qualify for a promotion; and the like.

A predetermined missing event pattern can define a series of a events, where it can be recognized when one of the defined events is missing, such as searching for a product or category, adding a product to a cart, but failing to checkout (e.g., finalize the order). Other missing event patterns can include: adding products to a cart, checking out, but encountering a payment authorization failure (or some other failure) that causes the order to not be submitted/processed; repeated viewing of a product specific page without the product being added to a cart; and the like.

A geo code or reverse geo code: near by, geo fence proximity, and/or geo filter patterns can define event associations that include location information, such as viewing a product specific page within the geo fence of a brick and mortar store. Other location information related patterns can include: searching for a product or category within the geo fence of a brick and mortar store; adding products to a cart and the product being in-stock at a nearby brick and mortar store, and the like.

A change detector pattern, up-trend pattern, and/or down-trend pattern can define event associations related to the changes in the value of a data point, where a change can be detected, an up-trend can be detected, or a down-trend can be detected. Example events can include an increase or decrease in the number of searches performed, an increase or decrease in the number of visits for a user (e.g., visits to a given website over a period of time), an increase or decrease in an amount spent at a website by a user (e.g., dollar amount spent over a period of time), and the like. Other example data points for which changes or trends can be detected are transactions types (e.g., changes to a number of order online pick up in store transactions or direct ship to customer transactions), a number of returns, and the like.

In some embodiments, these patterns can be combined (e.g., in a pipeline) such that a defined pattern can include any combination of the above described patterns, including, but not limited to: an ‘A’ followed by ‘B’ pattern with a location based pattern, multiple ‘A’ followed by ‘B’ patterns (or multiple iterations of any of the patterns), a missing event pattern with a location based pattern, and the like.

In some embodiments, a number of events can occur between, for example, an ‘A’ followed by ‘B’ pattern of events, and the predetermined pattern can still be recognized within the event stream. For example, for a pattern that includes an ‘A’ and ‘B’ event of adding and removing a product from a cart, the intervening events can include viewing different product pages, adding and/or removing other products from the cart, performing searches, and the like. In this example, the ‘A’ followed by ‘B’ pattern is recognized within the event stream among the intervening events. Other patterns can similarly be recognized in the presence of intervening events.

In some embodiments, a recognized pattern can be used to provide relevant information to internal systems/entities. For example, real-time information can be provided to various teams (e.g., customer experience, customer engagement, marketing, and others) on products viewed or searched in the last visit (or X visits) but not purchased by a user/visitor.

In some embodiments, contextual data about the electronic device or a user of the electronic device can be used to determine an intent. For example, this contextual data can include past online shopping behavior (e.g., past product purchases, a frequency for purchasing, a frequency for taking advantage of promotions, and the like), past products viewed (e.g., over a 30 day window), past searches, geolocation history, device type (e.g., mobile device, laptop, desktop), day of week/month and/or time of day behavior (e.g., day of week/month and/or time of day when a user typically views or browses versus when a user typically submits online purchases), weather history (e.g., current or forecasted/predicted weather), user demographic information, and the like.

In some embodiments, a contextual criteria can be used in addition to a recognized predetermined pattern. For example, when a pattern is recognized in a stream of events, contextual data for the corresponding user can be compared to a contextual criteria. The contextual criteria can be based on the recognized pattern. For example, when a pattern indicates repeated views of a product, the contextual criteria may relate to the frequency that the corresponding user takes advantage of promotions (e.g., buys products with promotions). When the frequency meets the contextual criteria (e.g., when the user regularly buys products with promotions), a corresponding action can be taken (e.g., a web push message/notification can be provided to the user with a promotion for the product that was repeatedly viewed).

In an example with a similar pattern, the contextual criteria may relate to the user's location and whether a brick and mortar store is nearby that has the product in-stock. If a store that has the product in stock is nearby (e.g., the contextual data meets the criteria), a corresponding action can be taken (e.g., a web push message/notification can be provided to the user that instructs the use of the availability of the product at the store).

In an example where the pattern represents a cart that has had a product removed, the contextual criteria can include the user's past transaction history with the product. For example, if the user has previously purchased the product (e.g., the contextual data meets the criteria), a corresponding action can be taken (e.g., a web push message/notification can be provided to the user that includes a web link for purchasing the product). In another example, if the user has not previously purchased the product (e.g., the contextual data meets a second criteria), a second corresponding action can be taken (e.g., a web push message/notification can be provided to the user that includes a web link for purchasing the product and a discount based on the first-time purchase).

In some embodiments, contextual data can be used to define the predetermined patterns. For example, a defined pattern can include a user's/electronic device's contextual information, such as a predetermined pattern that includes an order history that demonstrates repeated purchases of a product and an event stream that includes viewing of the product. In another example, a predetermined pattern can include a product of interest to a user, and that product of interest is subject to a promotion. In this example, it can be determined that a product is of interest to a user based on a user's contextual online shopping behavior (e.g., based on the user's previous orders, searches, product views, determined interests, and the like).

Based on the processing and analytics performed by stream analytics 310, one or more actions can be performed. For example, module 314 can perform real-time business intelligence functionality or can store relevant/insightful data in a data lake. Further, module 316 can perform an interaction with an electronic device/user, such as transmit a web push message to the electronic device based on a recognized pattern within a stream of events associated with the electronic device and/or contextual data associated with a user of the electronic device meeting a contextual criteria.

Embodiments can achieve the disclosed functionality using a number of technologies, frameworks, standards, and implementations. For example, Apache Kafka Streams API can be leveraged for stream processing. Apache Flink can also be used for streaming and batch processing in a high throughput, low latency mode. KSQL from Confluent, a streaming SQL engine that enables real-time data processing against Apache Kafka, can be used to analyze/process a Kafka stream. Apache Spark Streaming (from Databricks) is a scalable fault-tolerant streaming processing system that natively supports both batch and streaming workloads.

Oracle® BigData SQL (“BDSQL”) can query across Kafka topics (e.g., in flight data) and persisted data (e.g., in Oracle® relational databases, NoSQL data stores, Hadoop data lakes, and the like). In addition, the SQL Pattern matching functionality in the Oracle® 12c database can also be used to augment or in place of Oracle® Streaming Analytics pattern matching. Embodiments can also recognize patterns in sequences of events using SQL, for example by treating a sequence as a stream of rows, and using a row in a stream to represent an event. Embodiments of Oracle 12c database incorporate a MATCH_RECOGNIZE clause into the analytic function syntax to enhance pattern matching from SQL. Oracle® Sparkline can also be used with/in place of data lake business intelligence (e.g., at scale).

In some embodiments, content for the web push message/notification can be generated based on the recognized pattern and/or contextual data. For example, the web push notification can include promotions on a particular product, free shipping on a cart or free shipping once a certain threshold is reached by the cart, free shipping based on a timing for checking out a cart (e.g., checkout today), and the like. In another example, the recognized pattern and/or contextual data may relate to a location for the user/electronic device, and thus the web push notification can include an indication that a particular product is in stock near the user, a promotion on a buy online pick-up in store transaction, and other promotions based on the location. Other content for a web push notification can include an indication that the user has loyalty points to redeem, a web link that can be used to purchase a product, such as a product abandoned from a cart, and the like.

In some embodiments, a recognized pattern can indicate products searched/viewed/dwelled on but not purchased (e.g., on a user's last visit or last X visits). In this example, a positive product review for one of these indicated products can be included in a web push notification. In another example, a pattern can indicate a returning high-value shopper, and content for the web push notification can include: “Glad to see YOU back! We value your business! Have this discount offer XXX”. In another example, a recognized pattern can indicate that a user (e.g., anonymous user) views a product category but typically does not order its products (e.g., based on historical analysis). In this example, in which the anonymous user can be profiled as a “window shopper”, content for the web push notification can include an on-sale products page (e.g., a web link). In some embodiments, a timing (or a scheduled timing) for transmitting the web push message can be determined based on the recognized pattern and/or contextual data.

Embodiments can be implemented for a merchant's e-commerce web presence, such as a website. Consider a visitor to a merchant's website (e.g., using the OCCS, with the OCCS client configured as a progressive web application). The visitor's consent and opt-in to receive push notifications from the site can be retrieved based on a message to the visitor's electronic device. For example, the opt-in can be secured initially based on messaging, and subsequently web push messages can be sent to the user/electronic device based on this initial opt-in. In some embodiments, the opt-in must be secured before the visitor's electronic device can receive push messages. Thereafter, based on pre-determined detection patterns of the visitor's behavioral events (e.g., intent) and based on the visitor's context (e.g., past behavior, geolocation, device, audience, time of day, weather, demographics etc.), one or more relevant marketing/re-targeting/service oriented web push messages can be transmitted to the visitor's electronic device, which can be configured to display such a notification (e.g., in a mobile web browser in real-time). Such functionality can avert missed opportunities for the merchant, reduce friction with the shopping experience, and provide other tangible benefits that flow from better understanding a visitor's intent by way of behavioral analytics.

For example, a lost opportunity can be a contextual stream pattern with a visitor searching on site for a product or category, adding a product to a cart, and then removing the product from the cart. This can be similar to a flow in a brick and mortar store where a customer physically picks up a product, examines it, but places it back down (and in some instances, this interaction can be captured by sensing equipment, such as cameras). In this example, an intervention action (with a push notification) can be performed without the need for a native mobile application, for instance when a progressive web application is implemented by the merchant/cloud service provider. Embodiments include progressive web applications that provide utilities which are similar to conventional applications that are natively installed, including offline web pages, web push notifications, and improved load times. However, progressive web applications do not need to be downloaded/installed on the device itself, thus providing an enhanced online experience that is more likely to be adopted by the user/visitor.

Web push messages/notifications can be selectable (clickable) messages, sent to the user's/visitor's/subscriber's browsers and can appear next to the task bar (or in the display of a mobile device). These messages/notifications can be “browser based”, which means they can be accessible across different platforms and devices. In addition, whether users are connected through mobile devices, tablets, or desktops, web push messages/notifications can reach their devices in real-time. In addition, a web push notification can be displayed when the web browser is browsing any website. In some embodiments, the web push notifications can include selectable actions, such as hyperlinks, and rich media. Web push messages/notifications can be particularly effective, for example because they can be brief and can be delivered in real-time to increase user engagement and customer retention.

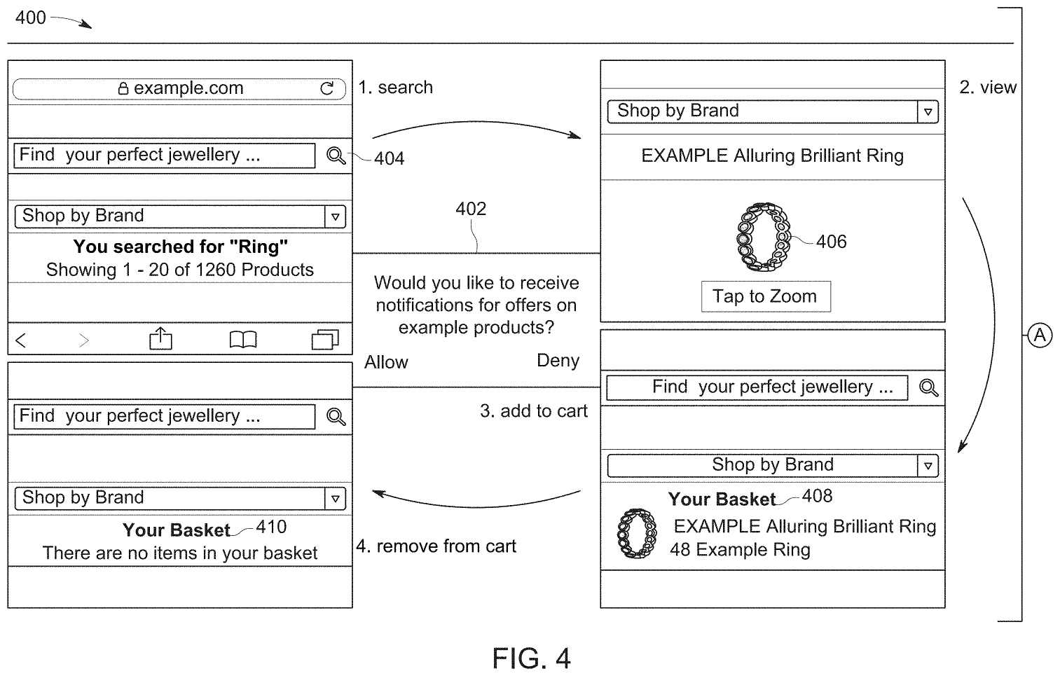

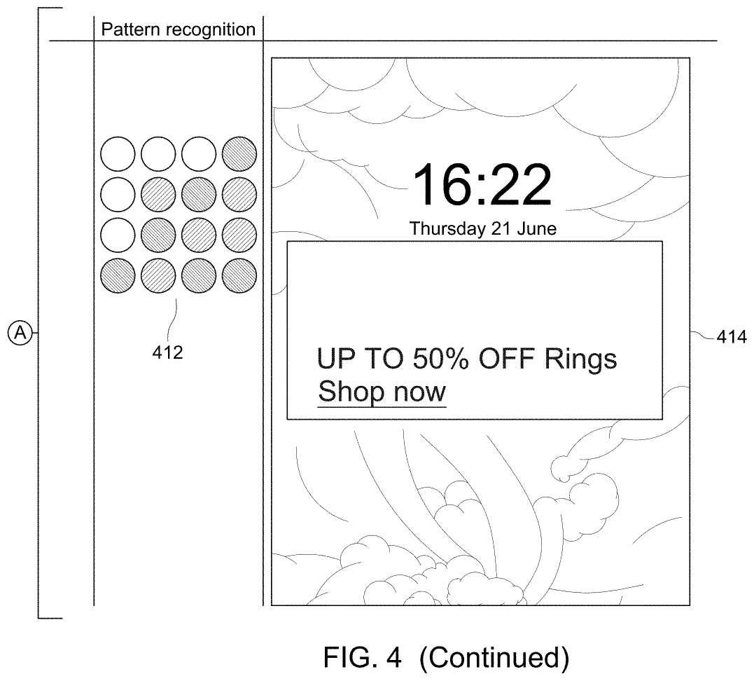

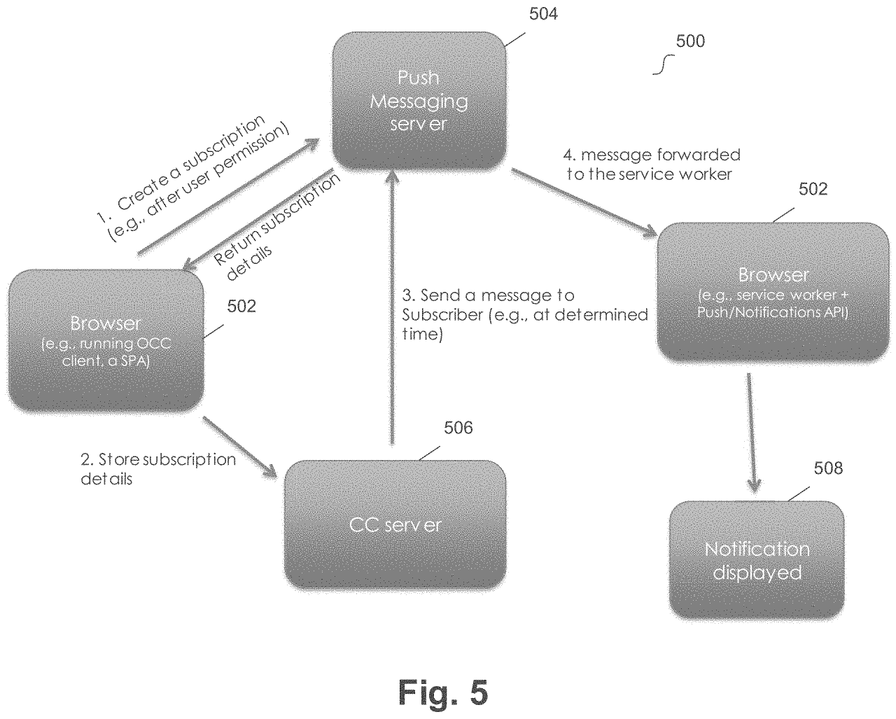

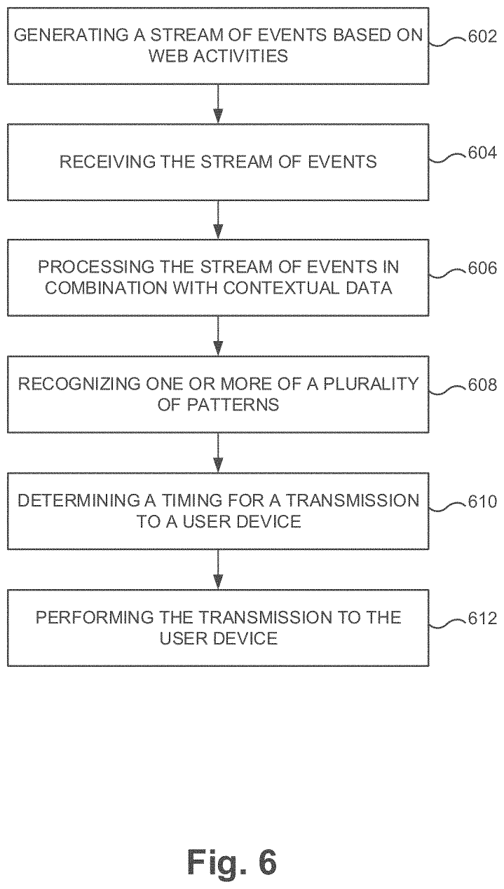

In some embodiments, a progressive web application can run alongside a client, such as commerce cloud client 102 of FIG. 1, and when a user/visitor visits an OCCS site they can opt-in to receiving web push messages/notifications. A service worker can be installed (along with a manifest file), on the user's/visitor's electronic device when the user's/visitor's electronic device visits the website (or the service worker could have been previously loaded when electronic device first visited the website). Based on the opt-in and using the service worker, web push messages/notifications can subsequently be received and displayed. FIG. 4 illustrates a flow diagram for generating a web push message based on a user's activity stream according to an example embodiment. In one embodiment, the functionality of FIG. 4 (and FIGS. 5 and 6 below) is implemented by software stored in memory or other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software. In embodiments, the functionality of FIGS. 4-6 can be performed by one or more elements of system 100 of FIG. 1 or system 210 of FIG. 2.

Opt-in Notification 402 can be displayed on a user electronic device, for example when the user loads a website using a web browser. The user can select the option to opt-in to receiving notifications, such as web push messages. A timing of the opt-in display can also be configured, such as for a time when the user has shown some interest in the website (e.g., after having navigated to a few webpages or viewed the website for a threshold amount of time, and the like). In some embodiments, a service worker can be download/installed/configured on the user's electronic device (e.g., configured with/alongside commerce cloud client 102) when the user/electronic device visits the website (or the service worker could have been previously loaded when the user/electronic device first visited the website). On the electronic device, the user can continue to browse the website, and in some embodiments the website can be hosted by a cloud service (e.g., commerce cloud service 104 of FIG. 1).

Using the web browser, the user can perform search 404, such as a search for a product (e.g., jewelry). After viewing search results, the user can select a product for viewing, such as a ring, and the web browser can subsequently load product page 406. In the illustrated example, the user can then add the corresponding product to a cart or basket and generate loaded cart 408. Subsequently in the illustrated example, the user can remove the corresponding product from the cart or basket to arrive at empty cart 410.

In some embodiments, the user's interactions with the website represent a user's web activity. As described herein, this web activity can be used to build a stream of events, which can be further processed and analyzed. For example, one of a plurality of predetermined patterns can be recognized within the user's event stream. Predetermined pattern 112 can be defined as an A followed by B pattern, where A represents an action that adds a product to a cart and B represents an action the removes the product for the cart. In this example, the adding of the product to generate loaded cart 408 and subsequent removal of the product that results in empty cart 410 can match the definition of predetermined pattern 412, and as such predetermined pattern 412 can be recognized in the user's event stream.

As a result, a web push message can be transmitted to the user's device that includes content relevant to the product that was added and then removed from the cart. For example, web push notification 414 that includes a promotion on the relevant product can displayed on the user's device based on the received web push message.

In some embodiments, a timing for the transmission can be based on the recognized pattern and/or on contextual data about the user. For example, an analysis of the contextual data about the user (e.g., online behavior) can indicate a tendency to view products during a certain time of day (e.g., during normal weekday work hours) and to purchase products during another time of day (e.g., during lunch on weekdays, or after normal work hours). As a result, the web push message can be transmitted at a time that corresponds to the user's tendency to purchase products. In some embodiments, a pattern is recognized or a contextual criteria is met when the user/electronic device is in a certain location, and thus the timing for the web push message is based on the user's location.

FIG. 5 illustrates a flow diagram for transmitting a web push message to a browser according to an example embodiment. For example, the functionality of FIG. 5 can be used to transmit a web push message that corresponds to web push notification 414 of FIG. 4.

A user's electronic device can include browser 502, which can run alongside a software client (e.g., cloud client) and can interact with a progressive web application. Using browser 502, a subscription can be created with push messaging server 504, for example after the user has opted-in to a service. The subscription details can include a public key, an authentication secret, and an endpoint (e.g., a URL to send the message to). In some embodiments, push messaging server 504 can be a Firebase Cloud Messaging Service, or any other suitable messaging service. The subscription information can be communicated from push messaging server 504 to browser 502, which in turn can communicate this subscription information to cloud service provider 506. After visiting a website/PWA, a service worker can also be loaded to interact with browser 502. Upon, for example, recognition of a pattern and/or contextual information for a user meeting a contextual criteria, cloud service provider 506 can transmit a web push message to browser 502 via push messaging server 504. For example, a web push notification that corresponds to the web push message can be displayed by display 508 of the user's electronic device.

In some embodiments, a notification can be a message displayed to a user outside of an application's normal user interface, such as the browser. A push message can be a message sent from the server to the client. A web push notification can be a notification created in response to a push message. A notifications API can be an interface used to configure and display notifications to the user (e.g., on the user's electronic device). A push API can be an interface used to subscribe an application, such as a PWA, to a push service and used to receive push messages in the service worker. A web push (or a web push message transmittal) can be an informal term referring to the process or components involved in the process of pushing messages from a server to a client on the web. A push service can be a system for routing push messages from a server to a client. For example, each browser can implement its own push service. A web push protocol describes how an application server or user agent interacts with a push service. In some embodiments, the functionality related to a web push notification can include a web push message transmitted (e.g., using a message service push API) and a corresponding notification being displayed (e.g., using a notification API).

The functionality of various embodiments is beneficial in a number of domains, such as domains where mobile application download rates can be low, first-time visitor rates can be high, or when it can be beneficial to engage with occasional visitors to a website, like retail and/or a number of other domains. In addition, these software techniques can be achieved when the visitor is registered or when the visitor is anonymous/unknown. In some embodiments, the web push message can be transmitted/received when the visitor has already left the site (in fact, the visitor's web browser could indeed have been closed). In addition, the visitor's device type can be a desktop, tablet, or smartphone, and multiple operating systems can be implemented.

FIG. 6 illustrates a flow diagram for processing an event stream using pattern recognition to communicate with a progressive web application according to an example embodiment. At 602, a stream of events can be built based on a user's web activities. For example, the user can be interacting with a browser and progressive web application running on the user's electronic device. In an embodiment, the user's electronic device has been configured with a service worker after the user has opted-in to the service. The user's interactions with the progressive web application via the browser can be used to build a stream of events. For example, an Apache Kafka producer/ecosystem can receive the user interactions and produce/build (or pipeline) the stream of events. Other suitable techniques for producing/building the stream of events can similarly be implemented.

At 604, the stream of events representative of a user's interactions with a web browser and a progressive web application can be received. For example, this stream of events can be received by a processing element, such as an Apache Kafka processing element. Other suitable techniques for processing the stream of events can similarly be implemented.

At 606, the stream of events can be processed in combination with contextual data. For example, contextual data about the user/user's electronic device can be accessed and processed along with the received stream of events. Other suitable techniques for processing the stream of events can similarly be implemented.

At 608, one of a plurality of predetermined patterns can be recognized within the stream of actions. For example, predetermined patterns can be defined by one or more events and/or contextual data or a contextual criteria. Recognizing the one pattern within the stream of actions and the contextual data can include matching one or more events from the stream of events to events defined for the one recognized pattern and matching contextual data about the user with contextual data defined for the one recognized pattern. In some embodiments, the matched events can include at least two events and the matched contextual data can include at least a transaction history for the user.

At 610, a timing for a transmission to the user's electronic device can be determined. For example, the timing for a web push message for transmission to the user's electronic device is based on the one recognized pattern or the contextual data. At 612, the transmission to the user's electronic device can be performed. For example, a web push message can be transmitted to the user's electronic device, such as at the determined timing. In some embodiments, a corresponding web push notification can be displayed on the user's electronic device using the configured service worker and/or browser.

Embodiments process an event stream using pattern recognition to communicate with a progressive web application. For example, a user can interact with a website using an electronic device, and the interaction can be achieved through a progressive web application that is running on the electronic device. The progressive web application can be used to generate an experience that is similar to a native application without the need to download and store such a native application. In some embodiments, the progressive web application can include a service worker, or a script that is executed alongside the progressive web application.

While the user navigates the website, a stream of events can be generated based on the user's actions. For example, searching (e.g., for a product, category, and the like), the viewing of a product specific page, adding an item to a cart, and any other suitable action can be added to the stream of events. The stream of events can be received and processed in order to recognize patterns. For example, a plurality of patterns that are defined by one or more events can be predetermined. One of the plurality of patterns can be recognized within the stream of events when the one or more events that define the pattern matches the stream of events.

In some embodiments, the system can include contextual data, such as data about the user of the electronic device, data about the electronic device, data associated with a geographic region, and the like, and a contextual criteria can be defined. For example, one of the plurality of patterns can be recognized within the stream of events when the one or more events that define the pattern matches the stream of events and the contextual criteria can be met when the contextual data that defines the criteria matches contextual data from the user, electronic device, geographic region, or relevant entity/circumstances (such as the entity/circumstances that the contextual data relates to, or a similar set of circumstances). In another example, one or more of the predetermined patterns can include a contextual criteria in addition to the one or more defined events. In this example, these patterns are matched to the events generated by the user's interactions and to the relevant contextual information.

In some embodiments, a web push message can be transmitted to the electronic device based on the recognized pattern. For example, the recognized pattern can indicate an opportunity to engage with the user of the electronic device. An example recognized pattern that relates to an e-commerce website can be an abandoned cart or a cart where an item has been removed. In this example, a web push message can be generated with content that relates to the abandoned cart, such as promotional materials or marketing material about the product or service removed from the cart or abandoned. Other recognized patterns can signal other user/visitor intent, and other action can be taken based on the particular pattern(s) recognized.

The predetermined patterns can indicate an intent of users/visitors, and thus recognition of one of the predetermined patterns within a particular user's event stream can be used to correlate the intent associated with the predetermined pattern to the particular user. For example, a predetermined pattern that resembles an abandoned cart can be associated with an intent to purchase a product, where this intent was interrupted or otherwise changed. In this example, there is an opportunity to engage with the particular user to recover this initial intent. For example, the user's intent may have been impacted by price, and thus a promotion may persuade the user to purchase the product. Other actions may similarly impact the user. Accordingly, recognition of a predetermined pattern within a user's event stream can be used to correlate an intent (e.g., an intent associated with the recognized predetermined pattern) to the user, and thus actions can be taken based on this intent, as further described herein.

In some embodiments, the recognized pattern and/or contextual information can also indicate a timing for transmitting the web push message, for example if more suitable to transmit the web push message at a later point in time (e.g., not in real-time). For example, an analysis of the user's online behavior can indicate a tendency to view products during a certain time of day (e.g., during normal weekday work hours) and to purchase products during another time of day (e.g., during lunch on weekdays, or after normal work hours). As a result, the web push message can be transmitted at a time that corresponds to the user's tendency to purchase products (and the user does not need to be on the merchant's website for the web push notification to be received/displayed).

Embodiments can display a web push notification that corresponds to the web push message on the display of the user's electronic device using the browser/service worker/progressive web application. For example, a service worker (e.g., a script) can be running alongside the progressive web application, and the service worker can be used to display the web push notification. In some embodiments, content for the web push notification can include an interface for engaging with the user. For instance, in the abandoned cart example, a web link (e.g., uniform resource locator) the can be used to purchase the product abandoned can be included with the web push notification. In other examples, the recognized pattern can indicate other content or techniques to engage with the user, and these items can be included in the relevant web push notification.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

We claim:

1. A method for processing an event stream using pattern recognition to communicate with a progressive web application, the method comprising:
receiving a stream of events representative of a user's interactions with a web browser and a progressive web application;
processing the stream of events in combination with contextual data about the user;
recognizing one of a plurality of predetermined patterns within the stream of events; and
transmitting a web push message to the user's electronic device based on the recognized pattern, wherein content of the web push message is generated based on the one recognized pattern.

2. The method of claim 1, wherein the stream of events is processed in combination with contextual data about the user.

3. The method of claim 2, wherein one of the plurality of predetermined patterns is recognized within the stream of events and the contextual data.

4. The method of claim 3, wherein content of the web push message is generated based on the one recognized pattern and the contextual data.

5. The method of claim 4, wherein a service worker is loaded onto the user's electronic device prior to transmitting the web push message, and a web push notification corresponding to the web push message is displayed on the user's electronic device by the service worker.

6. The method of claim 5, wherein the service worker comprises a script that is configured to execute alongside the web browser and the progressive web application.

7. The method of claim 4, wherein recognizing the one pattern within the stream of events and the contextual data further comprises matching one or more events from the stream of actions to actions defined for the one recognized pattern and matching contextual data about the user with contextual data defined for the one recognized pattern.

8. The method of claim 7, wherein the matched events comprise at least two events and the matched contextual data comprises at least a transaction history for the user.

9. The method of claim 8, wherein a scheduled timing for the web push message is based on the one recognized pattern or the contextual data.

10. The method of claim 4, wherein the stream of events is produced by an Apache Kafka producer and the stream of events is processed by an Apache Kafka processing element.

11. The method of claim 4, wherein the recognized pattern comprises at least one of an A followed by B pattern, an A not followed by B pattern, a missing event pattern, a duplicate events pattern, a change detector pattern, an up/down trend pattern, or a location based pattern.

12. The method of claim 4, wherein the contextual data comprises one or more of a transaction history for the user, a browsing pattern for the user, or a location of the user.

13. A non-transitory computer readable medium having instructions stored thereon that, when executed by a processor, cause the processor to process an event stream using pattern recognition to communicate with a progressive web application, wherein, when executed, the instructions cause the processor to:
receive a stream of events representative of a user's interactions with a web browser and a progressive web application;
process the stream of events in combination with contextual data about the user;
recognize one of a plurality of predetermined patterns within the stream of events; and
transmit a web push message to the user's electronic device based on the recognized pattern, wherein content of the web push message is generated based on the one recognized pattern.

14. The computer readable medium of claim 13, wherein the stream of events is processed in combination with contextual data about the user.

15. The computer readable medium of claim 14, wherein one of the plurality of predetermined patterns is recognized within the stream of events and the contextual data.

16. The computer readable medium of claim 15, wherein content of the web push message is generated based on the one recognized pattern and the contextual data.

17. The computer readable medium of claim 16, wherein a service worker is loaded onto the user's electronic device prior to transmitting the web push message, and a web push notification corresponding to the web push message is displayed on the user's electronic device by the service worker.

18. The computer readable medium of claim 16, wherein recognizing the one pattern within the stream of events and the contextual data further comprises matching one or more events from the stream of actions to actions defined for the one recognized pattern and matching contextual data about the user with contextual data defined for the one recognized pattern.

19. The computer readable medium of claim 18, wherein the matched events comprise at least two events and the matched contextual data comprises at least a transaction history for the user.

20. A system for processing an event stream using pattern recognition to communicate with a progressive web application, the system comprising:
a processor; and
a memory storing instructions for execution by the processor, the instructions configuring the processor to:
receive a stream of events representative of a user's interactions with a web browser and a progressive web application;
process the stream of events in combination with contextual data about the user;
recognize one of a plurality of predetermined patterns within the stream of events; and
transmit a web push message to the user's electronic device based on the recognized pattern, wherein content of the web push message is generated based on the one recognized pattern.
